(19) United States
(12) Patent Application Publication
(10) Pub. No.: US 2013/0334063 A1
(43) Pub. Date: Dec. 19, 2013

(54) Method of Detecting Analyte

(71) Applicant: GORDON & ROSENBLATT, LLC, New York, NY (US)

(72) Inventors: Aaron A. Rosenblatt, New York, NY (US); Gilbert Gordon, Oxford, OH (US); Gilbert Pacey, Oxford, OH (US)

(73) Assignee: Gordon & Rosenblatt, LLC, New York, NY (US)

(21) Appl. No.: 13/795,128

(22) Filed: Mar. 12, 2013

Related U.S. Application Data
(60) Provisional application No. 61/660,486, filed on Jun. 15, 2012.

(51) Int. Cl. G01N 27/417

(52) U.S. Cl. CPC G01N 27/417
USPC 205/778.5; 204/422; 204/415; 204/412

(57) ABSTRACT

This disclosure relates to a method of detecting an analyte. The method includes (1) contacting an aqueous solution containing the analyte with an electrochemical detector having a working electrode, a counter electrode, and a solid electrolyte, where the analyte includes a halogen or an oxy-halogen species and the solid electrolyte provides an electrical pathway between the working and counter electrodes; (2) applying a voltage to the detector; and (3) measuring the resultant current change in the detector.

### CROSS-REFERENCE TO RELATED APPLICATION

This application claims priority to U.S. Provisional Application No. 61/660,486, filed on Jun. 15, 2012, the contents of which are hereby incorporated by reference in their entirety.

### TECHNICAL FIELD

This disclosure relates to methods of detecting an analyte, as well as related electrochemical detectors, components, and systems.

### BACKGROUND

Disinfection of drinking water is one of the major public health advances in the 20th century. However, chemical disinfectants and their by-products may be toxic at high levels. Chemical disinfectants used to treat public drinking water supplies include chlorine gas, sodium hypochlorite, chlorine dioxide, monochloramines and ozone. Intensive research has been conducted with these disinfectants to address the trade-off between microbial control and the potential adverse health effects of chemical disinfectants and their by-products.

Chlorine is a popular disinfectant used to treat most public water supplies. Chlorine dioxide has recently emerged as an important alternative disinfectant. Chlorine reacts with water, i.e., hydrolyzes, and, depending on the pH, can form hypochlorite ion, hypochlorous acid and molecular chlorine, collectively called “free available chlorine” (FAC). Chlorine dioxide is highly soluble as a dissolved gas in water but does not hydrolyze. Chlorite ion is a by-product of chlorine dioxide use.

In the United States, drinking water treatment is covered by enforceable regulations of the US Environmental Protection Agency. Among other things, the regulations set a maximum residual disinfectant limit (MRDL) for chlorine dioxide in drinking water of 0.8 mg/L, and a maximum contaminant limit (MCL) for chlorite ion in drinking water of 1.0 mg/L. The MCL and MRDL represent the concentration of these two species in drinking water that has been determined to cause no adverse health effects.

Regulatory compliance requirements for using chlorine dioxide as a disinfectant include daily monitoring of chlorine dioxide and chlorite ion in drinking water that has been treated with chlorine dioxide. Analytic methods approved for compliance monitoring for chlorine dioxide or chlorite ion (e.g., ion chromatography or wet chemistry techniques) are generally complicated and time consuming.

### SUMMARY

This disclosure is based on the unexpected discovery that an analytical method employing a solid electrolyte (e.g., including a solid matrix and an electrically conducting material) formed from a sol gel process can be used reliably to measure the concentration of an analyte (e.g., an oxy-halogen species such as chlorite ion or chlorine dioxide) in a sample (e.g., a disinfected drinking water sample). The method can be used in an automated, online system (e.g., a flow injection analysis system) as an alternative to ion chromatography for routine monitoring of the analyte.

In one aspect, this disclosure features a method of detecting an analyte. The method includes (1) contacting an aqueous solution containing the analyte with an electrochemical detector having a working electrode, a counter electrode, and a solid electrolyte, (2) applying a voltage to the detector, and (3) measuring the resultant current change in the detector. The analyte includes a halogen or an oxy-halogen species. The solid electrolyte provides an electrical pathway between the working and counter electrodes.

In another aspect, this disclosure features a system that includes a sample-delivering device for delivering a sample containing an analyte into a carrier fluid; and an electrochemical detector for detecting the analyte. The detector is downstream from and in fluid communication with the sample-delivering device. The detector includes a working electrode, a counter electrode, and a solid electrolyte. The solid electrolyte provides an electrical pathway between the working and counter electrodes.

Embodiments can include one or more of the following features.

In some embodiments, the oxy-halogen species is an oxy-chlorine species (e.g., chlorite ion or chlorine dioxide). In some embodiments, the halogen or the oxy-halogen species can be a disinfectant (e.g., chlorine dioxide) or a by-product thereof (e.g., chlorite ion).

In some embodiments, the aqueous solution can include the analyte in the range of from about 0 mg/L to about 5 mg/L.

In some embodiments, the solid electrolyte can include a solid matrix and an electrically conducting material. The matrix can include an oxide (e.g., silica, alumina, titania, or zirconia) and the electrically conducting material can include ammonium hexafluorophosphate, magnesium chloride, or tetramethylammonium phosphate. In some embodiments, the matrix can be at least partially cross-linked. In some embodiments, during use, the amount of the electrically conducting material is substantially maintained in the solid electrolyte.

In some embodiments, the solid electrolyte is formed by a sol gel process. For example, the solid electrolyte can be formed from a dispersion or a solution containing an oxide precursor, a solvent, and an electrically conducting material, and optionally a surfactant.

In some embodiments, the oxide precursor can include an alkoxide, such as a silicon alkoxide (e.g., silicon tetraethoxide or silicon tetramethoxide).

In some embodiments, the surfactant can be an ethylene glycol monoether or a polyethylene glycol monoether (e.g., polyethylene glycol (1,1,3,3-tetramethylbutyl)phenyl ether).

In some embodiments, the solvent can include water, methanol, ethanol, or a mixture thereof.

In some embodiments, the sol gel process can be an evaporation-induced self-assembly process or an electrochemically-assisted self-assembly process.

In some embodiments, the detector can further include a reference electrode, and the solid electrolyte provides an electrical pathway between the reference electrode, the working electrode, and the counter electrode.

In some embodiments, the working electrode, counter electrode, or reference electrode can include platinum, gold, silver, graphite, glassy carbon, or a mixture thereof.

In some embodiments, the voltage can be applied to the detector by using amperometry or cyclic voltammetry. In some embodiments, the voltage can be capable of inducing redox reaction of the analyte.

In some embodiments, the voltage can be at least about −0.95 V (e.g., at least about −1.15 V). As used herein, the minus sign “−” before a voltage value indicates that the voltage is applied to an electrode.

In some embodiments, the system can further include a fluid-delivering device for delivering a carrier fluid and/or a sample collector for acquiring a sample.

In some embodiments, the system can further include a potentiometer electrically connected to the detector, in which the potentiometer is configured to apply a voltage to the detector.

In some embodiments, the system can further include an ammeter electrically connected to the detector, in which the ammeter is configured to measure a current change in the detector while a voltage is being applied.

In some embodiments, the system can further include a processor configured to analyze data obtained from the ammeter.

In some embodiments, the system can further include a gas diffusion cell downstream from the sample-delivering device and upstream from the detector. The gas diffusion cell can be in fluid communication with the sample-delivering device and the detector.

In some embodiments, the gas diffusion cell can include a membrane capable of separating gas molecules in the sample from ions (e.g., dissolved ions). In some embodiments, the membrane can also be capable of separating different types of gasses. As an example, the membrane can include polytetrafluoroethylene.

In some embodiments, the system can further include a first fluid-delivering device (e.g., a syringe pump) configured to deliver a donor stream to the gas diffusion cell. In some embodiments, the system can further include a second fluid-delivering device (e.g., a syringe pump) configured to deliver an acceptor stream to the gas diffusion cell.

In some embodiments, the gas diffusion cell can be configured such that the donor stream and the acceptor stream are in a countercurrent arrangement in the gas diffusion cell.

The gas diffusion cell can be configured to deliver either the donor stream or the acceptor stream to the detector.

In some embodiments, the system can include a separating device (e.g., a membrane or a gas diffusion cell containing a membrane) for separating constituents (e.g., dissolved ions or gases) in the sample prior to contacting the sample with the detector.

In some embodiments, the system can be a flow injection analysis system or a gas diffusion flow injection system.

Other features, objects, and advantages of the subject matter in this disclosure will be apparent from the description, drawings, and claims.

### DESCRIPTION OF DRAWINGS

FIG. 1 illustrates an exemplary electrochemical detector containing a solid electrolyte.

FIG. 2 illustrates an exemplary flow injection analysis (FIA) system containing the electrochemical detector shown in FIG. 1.

FIG. 3 illustrates an exemplary gas diffusion flow injection analysis system containing the electrochemical detector shown in FIG. 1.

FIG. 4 is a cyclic voltammogram of 50 mM chlorite ion at a platinized Pt disk macroelectrode obtained at a scan rate of 50 mV/S and a pH of 10.2.

FIG. 5 is a cyclic voltammogram of 44.1 mM chlorite ion obtained from the electrochemical detector described in Example 1 at a scan rate of 100 mV/s and a pH of 10.1.

FIG. 6A shows voltammograms of the electrochemical detector described in Example 1 recorded in deionized water in the presence of 44.1 mg/L chlorite ion at scan rates of 20-120 mV/s.

FIG. 6B shows linear relationship between the oxidation peak currents at 0.2 V obtained from FIG. 6A and the square root of the various scan rates.

FIG. 7 shows flow injection amperometry responses of the FIA system described in Example 2 to repeated injections of 1.0 mg/L chlorite ion at an applied potential of 0.40 V.

FIG. 8 shows the flow injection amperometric responses of the FIA system described in Example 2 to three 2.1 mg/L chlorite ion injections at an applied potential of 0.2 V. The data points in diamond correspond to % RSD values and the data points in square correspond to current values.

FIG. 9 shows a hydrodynamic voltammogram of 2.5 mg/L chlorite ion detected by the FIA system described in Example 2.

FIG. 10A is a flow injection amperometry spectrum of chlorite ion at concentrations of 5.00 mg/L, 2.50 mg/L, 1.25 mg/L, 0.63 mg/L, and 0.31 mg/L obtained from the FIA system described in Example 2.

FIG. 10B is the calibration curve obtained from the results shown in FIG. 10A.

FIG. 11A is a hydrodynamic voltammogram of solutions containing 14.8 μM chlorite ion, 14.8 μM potassium nitrate, 12.0 μM chlorate ion, and 10.0 μM perchlorate ion detected by the FIA system described in Example 2.

FIG. 11B is a hydrodynamic voltammogram of the solutions described in FIG. 11A except for the solution containing chlorite ion.

FIG. 12 shows cyclic voltammograms of 44.1 mM chlorite ion obtained from three separately fabricated prototype FIA systems described in Example 2 by using a scan rate of 100 mV/s and a pH of 10.1.

FIG. 13 shows flow injection amperometric calibration curves of chlorite ion obtained from the system described in Example 2. The calibration curves were obtained at chlorite ion concentrations of 2.0 mg/L, 1.0 mg/L, 0.8 mg/L, 0.4 mg/L, and 0.2 mg/L under an applied potential of 0.50 V.

FIG. 14 shows flow injection amperometric responses of a GD-FIA system described in Example 3 to three 3.8 mg/L chlorine dioxide injections at an applied potential of 0.0 V, as well as their % RSD vs. flow rate. The data points in diamond correspond to % RSD values and the data points in square correspond to current values.

FIG. 15 is a hydrodynamic voltammogram of 3.8 mg/L chlorine dioxide using the GD-FIA system described in Example 3 at a flow rate of 0.45 mL/min.

FIG. 16A is a flow injection amperometry spectrum of chlorine dioxide at different concentrations obtained from the GD-FIA system described in Example 3.

FIG. 16B is the calibration curve for the electrochemical detector obtained from FIG. 16A.

Like reference symbols in the various drawings indicate like elements.

### DETAILED DESCRIPTION

In general, this disclosure relates to use of an electrochemical detector containing a solid electrolyte (e.g., including a solid matrix and an electrically conducting material) that provides an electrical pathway between a working electrode and a counter electrode in the detector. The solid electrolyte can be formed from a sol gel process. The detector can be used in an automated system (e.g., a flow injection analysis system) for routine (e.g., daily) monitoring of a halogen or oxy-halogen analyte (e.g., a disinfectant or its by-product).

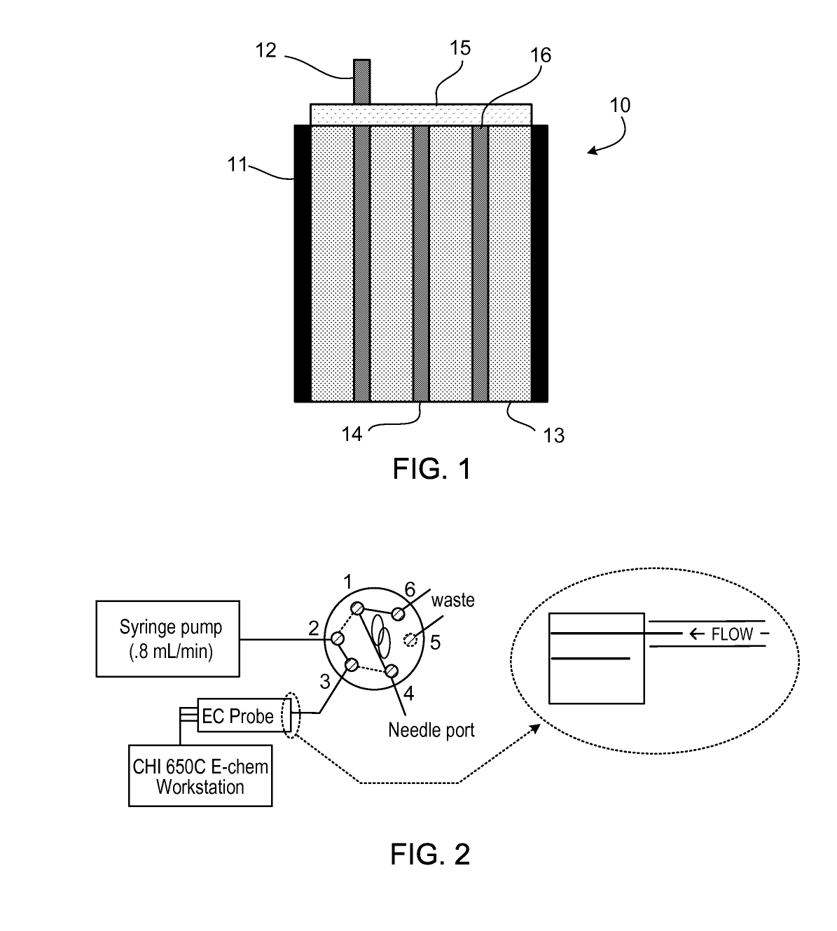

FIG. 1 illustrates an exemplary electrochemical detector containing a solid electrolyte described above. Referring to FIG. 1, electrochemical detector 10 includes a container 11, a working electrode 12, a supporting material 13, a counter electrode 14, a solid electrolyte 15, and an optional reference electrode 16. Container 11 can be made from any suitable material (e.g., a polymer, glass, ceramics, or a mixture thereof) and can be in any suitable shape or size (e.g., a tube having an outer diameter of about 0.6 cm and an inner diameter of about 0.4 cm). In some embodiments, container 11 can be omitted.

In general, supporting material 13 can be used to support working electrode 12, counter electrode 14, and/or optional reference electrode 16. Supporting material 13 can generally be made of any suitable material, such as a resin (e.g., an epoxy resin). In some embodiments, support material 13 can be formed after the working electrode, counter electrode, and optional reference electrode are disposed in container 11.

In general, working electrode 12, counter electrode 14, and optional reference electrode 16 can be disposed in container 11 in any manner as long as they are electrically connected. Referring to FIG. 1, counter electrode 14 and optional reference electrode 16 are embedded in supporting material 13 except that each electrode has a surface facing solid electrolyte 15 that is coplanar with the surface of support material 13 facing solid electrolyte 15. In such embodiments, solid electrolyte 15 covers the entire surfaces of counter electrode 14 and optional reference electrode 16 facing solid electrolyte 15 such that solid electrolyte 15 provides an electrical pathway connecting counter electrode 14 and optional reference electrode 16. In some embodiments, solid electrolyte 15 can at least partially covers the surfaces of counter electrode 14 and optional reference electrode 16 facing solid electrolyte 15 as long as counter electrode 14 and optional reference electrode 16 are electrically connected. In such embodiments, at least a portion of counter electrode 14 and at least a portion of optional reference electrode 16 can be exposed and can be in direct contact with a sample during use of detector 10.

As shown in FIG. 1, working electrode 12 can be partially embedded in supporting material 13 and partially covered by solid electrolyte 15. In such embodiments, a portion of working electrode 12 protrudes above supporting material 13 and solid electrolyte 15 such that it can be in direct contact with a sample during use of detector 10.

In general, each of working electrode 12, counter electrode 14, and optional reference electrode 16, independently, can be made from one or more electrically conductive materials. Examples of suitable conductive materials include platinum, gold, silver, graphite, glassy carbon, or a mixture thereof. In some embodiments, working electrode 12, counter electrode 14, and optional reference electrode 16 can be made from materials different from each other. For example, working electrode 12 and counter electrode 14 can be made from platinum, and optional reference electrode 16 can be made from silver.

Each of working electrode 12, counter electrode 14, and optional reference electrode 16 can generally have any suitable shape and size. For example, each of these electrodes can be a wire, a rod, or a plate. In some embodiments, working electrode 12 and counter electrode 14 can be a metal wire having a diameter from about 0.2 mm to about 0.6 mm (e.g., 0.4 mm), and optional reference electrode can be a metal wire having a diameter from about 0.05 mm to about 0.45 mm (e.g., about 0.25 mm).

In some embodiments, working electrode 12, counter electrode 14, and optional reference electrode 16 can be pretreated before solid electrolyte 15 is applied. For example, these three electrodes can be electrochemically pretreated by scanning the potential applied to the electrodes from a certain range (e.g., from about −1.0 to about 1.0 V vs Ag/AgCl) at a certain scan rate (e.g., about 0.1 V/s) in an acidic solution. Without wishing to be bound by theory, it is believed that the pretreatment can stabilize the electrode system.

In some embodiments, working electrode 12 functions as an anode and counter electrode 14 functions as a cathode. In some embodiments, working electrode 12 and counter electrode 14 can function as anode and cathode alternatingly (e.g., when a cyclic voltammetry is applied to these electrodes). Without wishing to be bound by theory, it is believed that, during use, working electrode 12 contacts an analyte and applies a desired potential to facilitate charge transfer to and from the analyte (e.g., by oxidizing the analyte). Without wishing to be bound by theory, it is believed that counter electrode 14 can pass the current needed to balance the current observed at working electrode 12. Without wishing to be bound by theory, it is believed that reference electrode 16 can have a fixed potential (e.g., a fixed reduction potential) so that the potential at working electrode 12 can be accurately measured and controlled.

In general, solid electrolyte 15 provides an electrical pathway between working electrode 12, counter electrode 14, and optional reference electrode 16. In some embodiments, solid electrolyte 15 can include a solid matrix and an electrically conducting material.

The solid matrix can be formed from an inorganic material, such as an oxide (e.g., silica, alumina, titania, or zirconia). In some embodiments, the solid matrix is at least partially (e.g., completely) cross-linked. In general, the solid matrix can have one or more of the following characteristics: chemically inert, electrically non-conductive, water insoluble, insensitive to temperature change (e.g., between 15-90° C.), insensitive to pH change (e.g., between 4-12), and/or insensitive to humidity change. In addition, the solid matrix is generally dimensionally stable so that it substantially maintains the electrically conducting material within the solid matrix during use of detector 10.

In some embodiments, the solid matrix in solid electrolyte 15 can be in the form of a film. In such embodiments, the film can have a thickness of at least about 0.01 mm (e.g., at least about 0.1 mm, at least about 1 mm, or at least about 5 mm) and/or at most about 100 mm (e.g., at most about 50 mm, at most about 25 mm, or at most about 10 mm). In some embodiment, the solid matrix can be a bulk solid (such as a plug). In such embodiments, the solid matrix can replace support material 13 shown in FIG. 1 to support working electrode 12, counter electrode 14, and optional reference electrode 16.

The electrically conducting material in solid electrolyte 15 can be substantially uniformly distributed throughout the solid matrix. In some embodiments, the electrically conducting material can be unevenly distributed in the solid matrix as long as solid electrolyte 15 has sufficient electrical conductivity. In general, the electrically conducting material can include electrically conducting salts. Examples of suitable electrically conducting salts include ammonium hexafluorophosphate, magnesium chloride, or tetramethylammonium phosphate.

In some embodiments, solid electrolyte 15 contains at least about 1 wt % (e.g., at least about 2 wt %, at least about 3 wt %, or at least about 5 wt %) and/or at most about 15 wt % (e.g., at most about 10 wt %, at most about 7 wt %, or at most about 5 wt %) of the electrically conducting material. In some embodiments, the amount of the electrically conducting material is substantially maintained in solid electrolyte 15 during use of detector 10. Without wishing to be bound by theory, it is believed that, by using solid electrolyte 15, detector 10 can be used to detect an analyte (e.g., chlorite ion or chlorine dioxide) in an aqueous sample repeatedly without losing the electrically conducting material. As a result, detector 10 can be incorporated into an automated system (e.g., a flow injection analysis system) to replace conventional methods (e.g., wet chemistry techniques) for routine (e.g., daily) monitoring of a halogen or oxy-halogen analyte in water.

In general, solid electrolyte 15 can be made by a sol gel process, such as an evaporation-induced self-assembly process or an electrochemically-assisted self-assembly process. For example, solid electrolyte 15 can be formed by (1) mixing an oxide precursor, a solvent, and an electrically conducting material described above, and optionally a surfactant to form a dispersion or a solution, (2) disposing the dispersion or a solution onto a surface of support material 13 (in which working electrode 12, counter electrode 14, and optional reference electrode 16 are at least partially embedded) for receiving a sample, (3) drying the dispersion or solution (e.g., by evaporation under ambient conditions). Examples of suitable oxide precursors include alkoxides, such as silicon alkoxides (e.g., silicon tetraethoxide or silicon tetramethoxide) or metal alkoxides (e.g., aluminum tetraethoxide or titanium tetraethoxide). Examples of suitable solvents can be water, methanol, ethanol, or a mixture thereof. Without wishing to be bound by theory, it is believed that, in some embodiments, the oxide precursor can be hydrolyzed (e.g., either at room temperature or at a temperature higher than room temperature) in the dispersion or solution to form a polymer (i.e., a sol) through, for example, a condensation reaction. Drying the dispersion or solution would allow the sol to continue to polymerize to form a three-dimensional cross-linked network, which results in the solid matrix (i.e., an oxide such as silica, alumina, titania, or zirconia) in solid electrolyte 15. A more detailed explanation of the sol gel process is described in the Master Thesis by John Nicholas Myers, entitled “An Automated, On-Line Electrochemical Chorite Ion Detector,” submitted to the Department of Chemistry and Biochemistry of Miami University around May, 2011.

In some embodiments, the oxide precursor and/or the electrically conducting material can be dissolved in the solvent to form a sol gel solution. In some embodiments, the oxide precursor and/or the electrically conducting material can be dispersed in the solvent to form a sol gel dispersion. In such embodiments, the oxide precursor and/or the electrically conducting material can be added to the solvent as particles. Such particles can have an average particle size of at least about 1 nm (e.g., at least about 10 nm or at least about 50 nm) and/or at most about 1,000 nm (e.g., at most about 500 nm or at most about 100 nm).

In some embodiments, solid electrolyte 15 can be made by a template-based sol gel process. For example, the dispersion or solution described above can include a surfactant as a template such that gelation can occur around the surfactant. Subsequent removal of the surfactant can result in a porous solid electrolyte 15. Examples of suitable surfactants include an ethylene glycol monoether (e.g., ethylene glycol phenyl ether) or a polyethylene glycol monoether (e.g., polyethylene glycol (1,1,3,3-tetramethylbutyl)-phenyl ether).

In general, detector 10 can be prepared by methods known in the art. For example, detector 10 can be prepared by (1) disposing working electrode 12, counter electrode 14, and optional reference electrode 16 in container 11, (2) forming supporting material 13 in container 11 such that the electrodes are at least partially embedded in supporting material 13, and (3) forming solid electrolyte 15 on supporting material 13 (e.g., by a sol gel process described above) such that solid electrolyte 15 provides electrical pathway among the three electrodes. In some embodiment, solid electrolyte 15 can replace support material 13 to support working electrode 12, counter electrode 14, and optional reference electrode 16 in container 11.

In general, the electrochemical detector described herein can be used to detect an analyte in a sample (e.g., an aqueous sample). For example, the electrochemical detector can be used to detect the amount of an oxy-halogen disinfectant (e.g., chlorine dioxide) or its by-product (e.g., chlorite ion) in a water sample that has been treated by the disinfectant. In some embodiments, the analyte that can be detected by the electrochemical detector can include a halogen (e.g., chlorine or bromine) or an oxy-halogen species (e.g., an oxy-chlorine). As used herein, the term “an oxy-halogen species” refers to a species (e.g., a compound or an ion) that contains both oxygen and halogen (e.g., F, Cl, Br, or I) atoms. Examples of suitable oxy-halogen include chlorine dioxide (ClO₂), chlorite ion (ClO₂⁻), chlorate ion (ClO₃⁻), perchlorate ion (ClO₄), hypochlorous acid (HOCl), or hypochlorite ion (ClO⁻).

Without wishing to be bound by theory, it is believed that, during use of the electrochemical detector described herein, applying a suitable voltage to the detector can induce redox reactions of a halogen or an oxy-halogen species in a sample at the working and/or counter electrodes, which result in an electrical current change in the detector. Measurement of the current change can determine the concentration of the halogen or oxy-halogen species in the sample. A suitable voltage can be at least about −0.61 V (e.g., at least about −0.95 V, at least about −1.15 V, at least about −1.19 V, at least about −1.21 V, at least about −1.47 V, at least about −1.61 V, or at least about −1.65 V) and/or at most about −1.65 V (e.g., at most about −1.61 V, at most about −1.47 V, at most about −1.21 V, at most about −1.19 V, at most about −1.15 V, or at most about −0.95 V). As mentioned above, the minus sign “−” refers to the direction of the voltage (i.e., the voltage is being applied to an electrode). In addition, as used herein, the terms “voltage” and ‘potential” are used interchangeably. Without wishing to be bound by theory, it is believed that the redox potentials of certain oxy-chlorines and bromide are those listed in the table below.

| Molecule | Reactions (Oxidation) | Potential (V) |
|---|---|---|
| ClO₂⁻ | ClO₂⁻ ⇄ ClO₂ + e⁻ | −.954 |
| ClO₂ | ClO₂ + H₂O ⇄ ClO₃⁻ + 2H⁺ + e⁻ | −1.152 |
| ClO₂⁻ | HClO₂ + H₂O ⇄ ClO₃⁻ + 3H⁺ + 2e⁻ | −1.214 |
| ClO₃⁻ | ClO₃⁻ + H₂O ⇄ ClO₄⁻ + 2H⁺ + 2e⁻ | −1.189 |
| Cl₂ | .5Cl₂(g) + 3H₂O ⇄ ClO₃⁻ + 6H⁺ + 5e⁻ | −1.470 |
| Cl₂ | .5Cl₂(g) + H₂O ⇄ HClO + H⁺ + e⁻ | −1.611 |
| ClO⁻ | HOCL + H₂O ⇄ HClO₂ + 2H⁺ + 2e⁻ | −1.645 |
| Br⁻ | Br⁻ + 6OH⁻ ⇄ BrO₃⁻ + 3H₂O + 6e⁻ | −.610 |

As an example, without wishing to be bound by theory, it is believed that, applying a potential between about −0.95 V and about −1.15 V could induce redox reactions of redox couple ClO₂⁻/ClO₂ in a sample (e.g., a water sample that has been treated with chlorine dioxide) at the working and/or counter electrodes in the detector and the resultant current change can be used to determine the concentration of chlorite ion (ClO₂⁻) in the sample. As another example, without wishing to be bound by theory, it is believed that, after removing chlorite ion from a sample treated with chlorine dioxide (e.g., by using a selective gas permeable membrane such as TEFLON®), applying a potential between about −1.15 V and about −1.19 V could induce redox reactions of redox couple ClO₂/ClO₃⁻ in a sample (e.g., a water sample that has been treated with chlorine dioxide) at the working and/or counter electrodes in the detector and the resultant current change can be used to determine the concentration of chlorine dioxide in the sample. Because of the removal of chlorite ion prior to contacting the sample with the detector, the potential interference from chlorite ion can be avoided.

In general, a voltage can be applied to the electrochemical detector described herein by using methods known in the art. For example, a voltage can be applied to the detector by using a potentiometer using amperometry (e.g., single-potential amperometry or pulsed amperometry) or cyclic voltammetry.

In general, the electrical current change generated in the detector can be measured by methods known in the art. For example, the current change in the detector can be determined by using a current-measuring device (e.g., an ammeter).

In some embodiments, the concentration range of the analyte that can be measured by the detector described herein can be from about 0 mg/L to about 5 mg/L (e.g., from about 0.01 mg/L to about 2 mg/L, from about 0.01 mg/L to about 1 mg/L, from about 0.01 mg/L to about 0.5 mg/L, or from about 0.02 mg/L to about 0.2 mg/L). In general, the amount of chlorine dioxide or chlorite ions in drinking water that has been treated by chlorine dioxide falls within the above range.

This disclosure also features a method of detecting an analyte. In some embodiments, the method includes (1) contacting an aqueous solution containing the analyte with an electrochemical detector having a working electrode, a counter electrode, and a solid electrolyte, where the analyte includes a halogen or an oxy-halogen and the solid electrolyte provides an electrical pathway between the working and counter electrodes; (2) applying a voltage to the detector; and (3) measuring the resultant current change in the detector. For example, the electrochemical detector can be detector 10 described above in connection with FIG. 1. In some embodiments, after the detection is complete, a voltage (e.g., a pulsed voltage) can be applied to the working and counter electrodes to clean or reactivate these electrodes (e.g., by reducing the oxidized species on the working electrode and/or oxidizing the reduced species on the counter electrode).

In some embodiments, a sample (e.g., a water sample that has been treated by a disinfectant such as chlorine dioxide) can contain two or more analytes (e.g., chlorine dioxide and chlorite ion) having different oxidation potentials. In such embodiments, the presence of the analyte having a lower oxidation potential can interfere with the measurement of the analyte having a higher oxidation potential, as the former will also be oxidized when a suitable voltage is used to oxidize the latter. In such embodiments, to measure the amount of the analyte having a higher oxidation potential (e.g., chlorine dioxide), the detecting method described herein can include an addition step of removing the analyte having a lower oxidation potential (e.g., chlorite ion) before contacting the sample with the electrochemical detector. The removing step can be performed by using a membrane (e.g., a selective gas permeable membrane). The membrane can be made from any suitable materials. An exemplary material is a polytetrafluoroethylene. Commercially available polytetrafluoroethylene membranes include TEFLON membranes. In some embodiments, a membrane can be used separate a non-gas species (e.g., chlorite ion) from a gas species (e.g., chlorine dioxide). In some embodiments, a membrane can be used to separate a gas species (e.g., chlorine dioxide) from another gas species (e.g., chlorine).

This disclosure also features a system (e.g., an automated system) that includes the electrochemical detector described herein for periodically measuring an analyte. Examples of such a system include a flow injection analysis (FIA) system or a gas diffusion flow injection analysis (GD-FIA) system.

In some embodiments, the system can include a sample-delivering device (e.g., an injection valve) for delivering a sample containing an analyte into a carrier fluid (e.g., deionized water), and an electrochemical detector for detecting the analyte. The detector can be downstream from and in fluid communication with the sample-delivering device.

The detector can be one of the detectors described herein. For example, the detector can include a working electrode, a counter electrode, an optional reference electrode, and a solid electrolyte, where the solid electrolyte provides an electrical pathway between the working electrode, the counter electrode, and the optional reference electrode. In some embodiments, the detector can be incorporated into a flow cell, such as a thin-layer flow cell or a wall-jet flow cell. In a thin-layer flow cell, a carrier fluid generally flows through a thin rectangular channel that contains an embedded working electrode of the detector. In a wall-jet flow cell, a carrier fluid generally flows directly against an embedded working electrode of the detector.

In some embodiments, the system can include a membrane configured to prevent certain non-gas species (e.g., ions such as chlorite ion) or gas species (e.g., chlorine) in the sample from reaching the detector. In some embodiments, the membrane can be placed at any suitable place in the system that is upstream from the detector to remove the undesired non-gas or gas species.

In some embodiments, the system can further include (1) one or more fluid-delivering devices (e.g., a syringe pump) for delivering one or more carrier fluids, (2) a sample collector for acquiring a sample, (3) a potentiometer electrically connected to the detector and configured to apply a voltage to the detector, (4) an ammeter electrically connected to the detector and configured to measure a current change in the detector while a voltage is being applied, and (5) a processor (e.g., a computer) configured to analyze data obtained from the ammeter.

As an example, FIG. 2 illustrates an exemplary flow injection analysis (FIA) system containing the electrochemical detector described herein. In some embodiments, such a FIA system can be used to determine the concentration of chlorite ion of a water sample treated by chlorine dioxide. Referring to FIG. 2, the FIA system includes a syringe pump for delivering a carrier fluid (e.g., an aqueous fluid such as water), an injection valve for delivering a sample containing an analyte into the carrier fluid, an electrochemical detector (i.e., the “EC probe” shown in FIG. 2) downstream from the injection valve, and a processor (i.e., the “CHI 650C E-chem Workstation” shown in FIG. 2). During use, a voltage selected based on the intended analyte (e.g., from about 0.9 V to about 1.15 V) can be applied to the detector. After a sample containing an analyte (e.g., chlorite ion) is injected into the carrier fluid and contacts the detector, the analyte can be oxidized at the working electrode, which can result in a current change in the detector. The current change can then be recorded and analyzed by the processor to determine the concentration of the analyte.

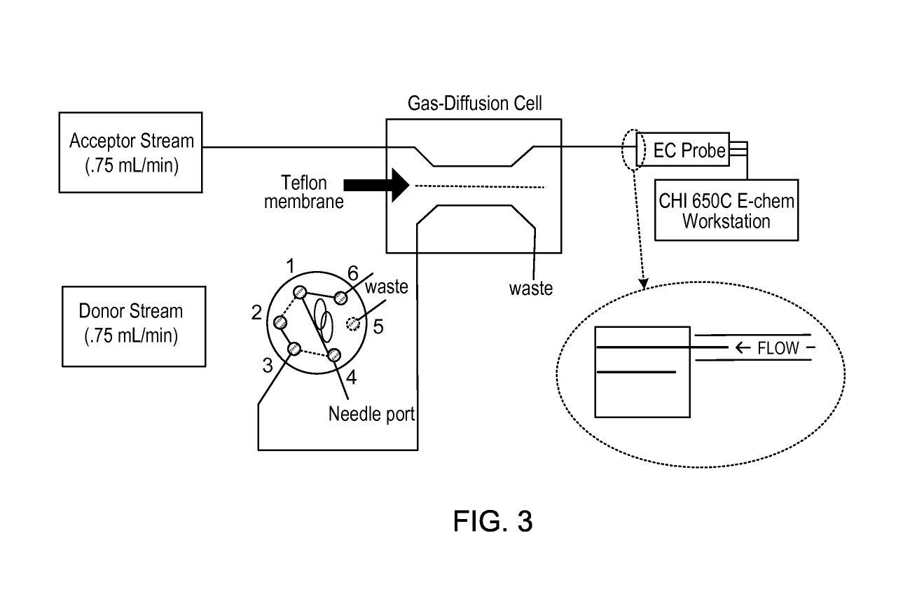

As another example, FIG. 3 illustrates an exemplary gas diffusion flow injection analysis (GD-FIA) system containing the electrochemical detector described herein. Referring to FIG. 3, the GD-FIA system includes a first fluid-delivering device (e.g., a syringe pump) for delivering a donor stream (also referred to as a donor carrier fluid), an injection valve for delivering a sample containing an analyte into the donor stream, a second fluid-delivering device for delivering an acceptor carrier stream (also referred to as an acceptor carrier fluid), a gas diffusion cell downstream from the first and second fluid delivery devices and the injection valve, an electrochemical detector (i.e., the “EC probe” shown in FIG. 3) downstream from the gas diffusion cell, and a processor (i.e., the “CHI 650C E-chem Workstation” shown in FIG. 3). In some embodiments, the GD-FIA system can be used to remove chlorite ion in a water sample treated by chlorine dioxide and measure the concentration of the chlorine dioxide in the sample.

As shown in FIG. 3, the gas diffusion cell includes a TEFLON® membrane, which can separate non-gas species (e.g., dissolved ions such as chlorite ion) from gas species (e.g., chlorine dioxide) or separate one gas species (e.g., chlorine dioxide) from another gas species (e.g., chlorine) in a sample. In some embodiments, the membrane can be placed at any suitable place in the system that is upstream from the detector. For example, the gas diffusion cell can be omitted and the membrane can be place immediately before the detector to serve the same functions described above.

In general, the gas diffusion cell can be configured such that the donor stream and the acceptor stream are in a countercurrent arrangement (i.e., the donor and acceptor streams flow in opposite directions), a parallel-current arrangement (i.e., the donor and acceptor streams flow in the same direction), or a cross-current arrangement in the gas diffusion cell.

In general, the gas diffusion cell can be configured to deliver either the acceptor stream or the donor stream to the detector depending on where the analyte to be detected is located.

The contents of all publications cited herein (e.g., patents, patent application publications, and articles) are hereby incorporated by reference in their entirety.

The following examples are illustrative and not intended to be limiting.

### Example 1

### Fabrication of an Electrochemical Detector Containing a Solid Electrolyte and Measurement of Chlorite Ion Concentrations

All glassware was washed with soap and water followed by a 24 hour soak in ˜1 v/v % nitric acid, then soaked in dilute Clorox bleach for at least 24 hours and removed just prior to use.

An electrochemical detector was fabricated using a solid electrolyte made from a silica sol gel. The precursor to the silica sol gel was tetraethyl orthosilicate (TEOS) with a 99.999% purity, obtained from Sigma Aldrich Chemical Company (Aldrich), St. Louis, Mo. House-distilled water deionized with a Barnstead NANOpure II system (Thermo Fisher Scientific) and spectrophotometric-grade ethanol (Aldrich) were used as co-solvents in the preparation of the silica. Triton X-114 obtained from Sigma Chemical Co., St Louis, Mo. (Sigma) was used as a surfactant template. Ammonium hexafluorophosphate with a purity of higher than 95% was added as an electrically conducting material in the gelation process to prepare a silica sol gel. The analyte was ultra-pure sodium chlorite, >99.9% purity (Gordon Laboratory, Miami University, Ohio).

Specifically, platinum wires (0.2 mm diameter) were used to form the working electrodes, counter electrodes and quasi-reference electrodes. The electrodes were supported in a 0.6 cm outer diameter (OD), 0.4 cm inner diameter (ID) plastic tube filled with an epoxy resin made by mixing EPO-TEK 353ND Part A and Part B (Epoxy Technology, Inc., Billerica, Mass.) in a 10:1 ratio by weight. The epoxy was cured for 30 minutes at 80° C., after which its surface was smoothed with 400 grit sandpaper. The counter and reference electrodes were coplanar with the surface of the epoxy receiving an analyte, and the working electrode protruded above this surface. The three electrodes were electrochemically pretreated prior to sol gel deposition by scanning the potential from −1.0 V to 1.0 V vs. Ag/AgCl at 0.1 V/s in 0.1 M sulfuric acid. The surface of the epoxy was then coated with a silica sol gel solid-electrolyte film cast from 5 μL of sol. The sol consisted of 0.1 mL of TEOS, 9.0 mL of ethanol, 1.0 mL of water, 0.6 mL of water saturated with NH₄ PF₆, and 0.2 mL of Triton X-114. The sol was magnetically stirred for 2 hours prior to use for film formation. The gelation time was seven days under ambient laboratory conditions. A portion of the working electrode and all surfaces of the reference and counter electrodes that were coplanar with the surface of the epoxy were coated with silica sol gel using this procedure.

The electrochemical behavior of chlorite ion was evaluated by the electrochemical detector formed above using cyclic voltammetry. All electrochemical measurements were made with a model 650C electrochemical workstation from CH Instruments (Austin, Tex.). All potentials were measured and reported vs. a Pt/PtO quasi-reference electrode unless otherwise indicated.

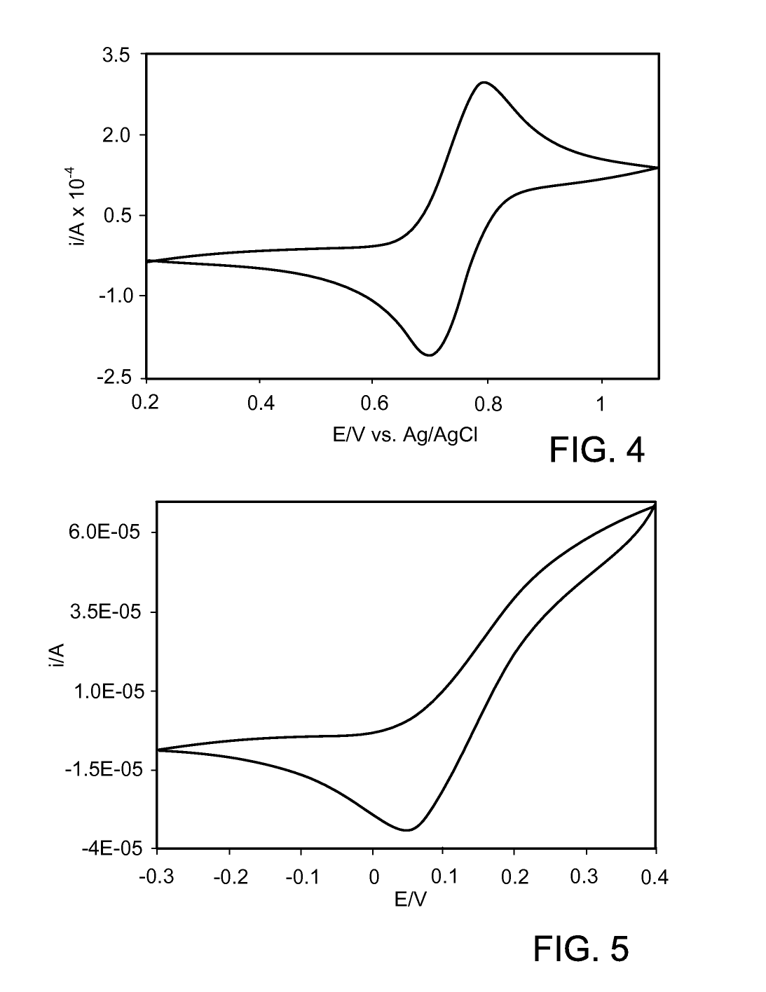

FIG. 4 is a cyclic voltammogram of 50 mM chlorite ion (ClO₂⁻) at a platinized Pt disk macroelectrode (which is the not the electrochemical detector described above) obtained at a scan rate of 50 mV/S and a pH of 10.2. As shown in FIG. 4, 50 mM chlorite ion exhibited a peak separation of 0.098 V with an E⁰ of 0.75 vs. Ag/AgCl in the cyclic voltammogram. The anodic-to-cathodic peak current ratio was 1.04. Without wishing to be bound by theory, it is believed that the above results are consistent with general understanding of the reversible behavior of the chlorite/chlorine dioxide redox couple. Further, without wishing to be bound by theory, it is believed that the slight deviation from ideal behavior in the peak separation can be attributed to slow heterogeneous charge transfer kinetics. In addition, 50 mM chlorate and perchlorate ions that were added to the sample containing 50 mM chlorite ion could not be distinguished from the deionized water background, which demonstrates the selectivity of the measurement for chlorite ion.

FIG. 5 is a cyclic voltammogram of 44.1 mM chlorite ion obtained from the electrochemical detector prepared above at a scan rate of 100 mV/s and a pH of 10.1. As shown in FIG. 5, 44.1 mM chlorite ion exhibited a peak separation of ˜0.25V, a gradually increasing oxidation current and a reduction peak. Without wishing to be bound by theory, it is believed that the additional peak separation compared to the platinized Pt electrode can be attributed to uncompensated resistance in the solid-phase electrolyte. Further, without wishing to be bound by theory, it is believed that the gradually increasing oxidation current is due to a hindrance of chlorite ion mass transfer to the electrode surface caused by the electrostatic repulsion of the negatively charged ion from the negatively charged silanol groups on the sol gel. The peak for the reduction of chlorine dioxide to chlorite ion supports this explanation, because chlorine dioxide is not charged. Surface fouling of the Pt may also contribute to the distortion of the oxidation peak. 10.0 mg/L chlorate and perchlorate ions that were added to the sample containing 44.1 mM chlorite ion could not be distinguished from the deionized water background, which demonstrates the selectivity of the measurement for chlorite ion.

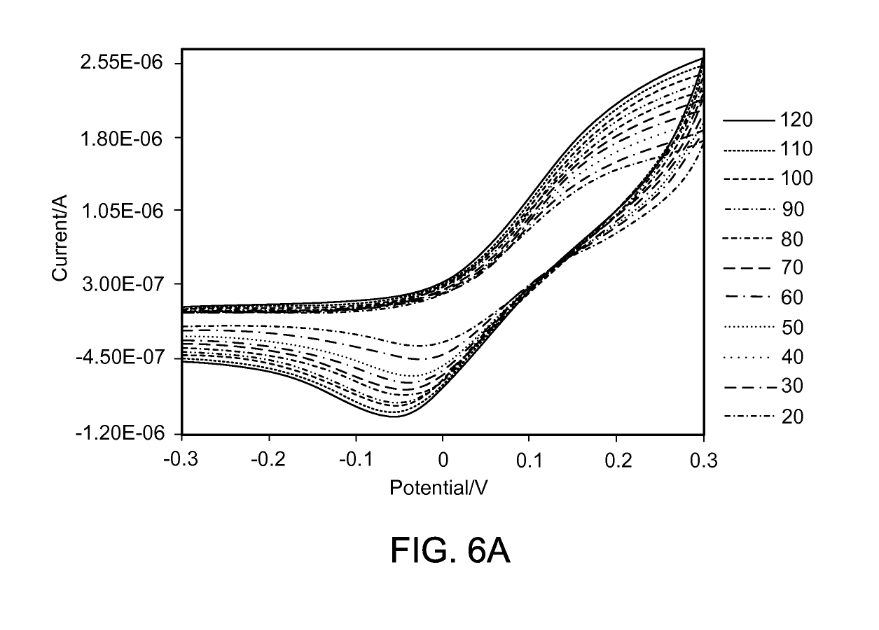

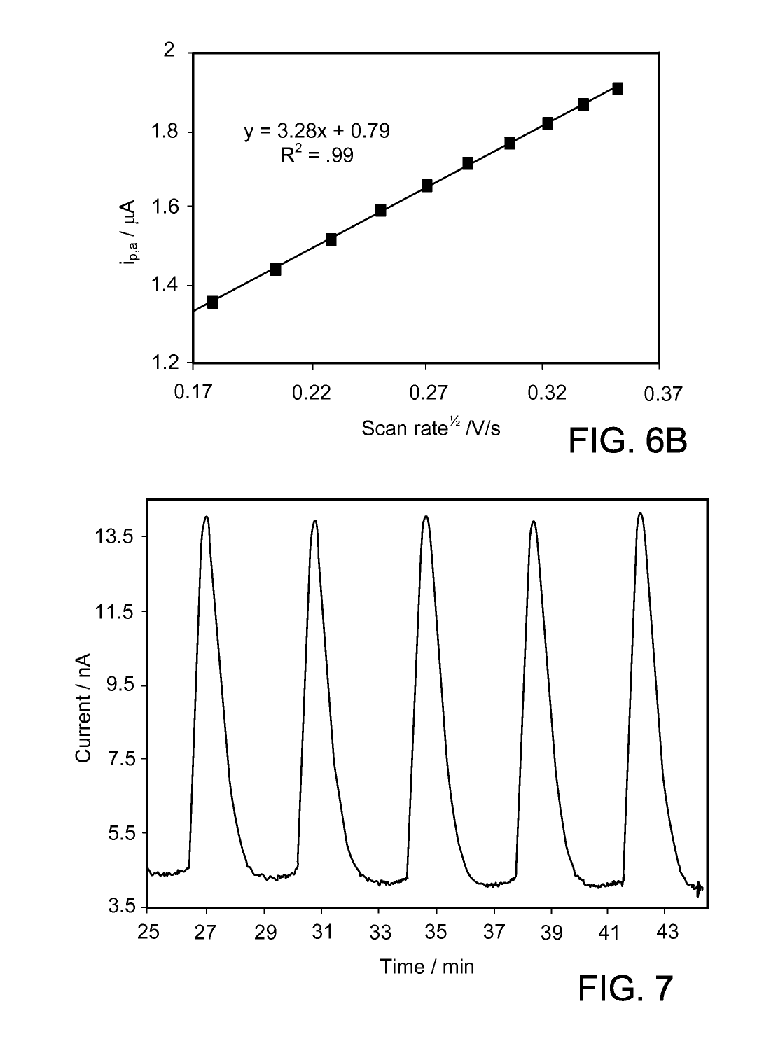

FIGS. 6A and 6B illustrate the results of a scan rate study of 44.1 mM chlorite ion by the electrochemical detector prepared above. Specifically, the diffusion of chlorite ion to the surface of the electrochemical detector was analyzed by plotting the oxidation peak currents at 0.2 V obtained from cyclic voltammograms at different scan rates against the square root of each scan rate. FIG. 6 A illustrates voltammograms recorded in deionized water in the presence of 44.1 mg/L chlorite ion at scan rates of 20-120 mV/s.

FIG. 6B illustrates linear relationship between the oxidation peak currents at 0.2 V and the square root of the various scan rates, which indicates that the oxidation of chlorite ion at the electrochemical detector is mass transfer limited and that the electrochemical detector could be used to measure the concentration of chlorite ion in a sample.

### Example 2

### Fabrication of a Flow Injection Analysis (FIA) System Including an Electrochemical Detector and Measurement of Chlorite Ion Concentrations

A FIA system was fabricated by connecting a syringe pump to a Rheodyne 7125 6-port syringe loading injection valve with a 250 uL external sampling loop. The flow cell detector used in this system was an electrochemical flow cell produced by inserting the protruding portion of the working electrode in an electrochemical detector prepared in Example 1 directly into the downstream flow from the injector. The carrier stream used in the FIA system was deionized water. The flow rate of the carrier stream was 0.8 mL/min unless otherwise indicated. The system used 0.5-mm-id Tygon tubing. Fixed-potential amperometric i-t curves were recorded using this FIA system and the resultant peak heights were measured using GRAMS/32AI software.

The flow cell detector described above was tested using amperometry to measuring response to repeated injections of 1.0 mg/L chlorite ion at an applied potential of 0.40 V. The results are summarized in FIG. 7. As shown in FIG. 7, asymmetric peaks were observed that rose sharply and decayed slowly with a baseline-to-baseline time of approximately three minutes. The asymmetric peaks were representative of injected plugs that have undergone dispersion, which suggests that the dead volume between the tubing and the three-phase boundary (3PB) between the analyte solution, the electrodes and the electrically conductive sol gel is very small.

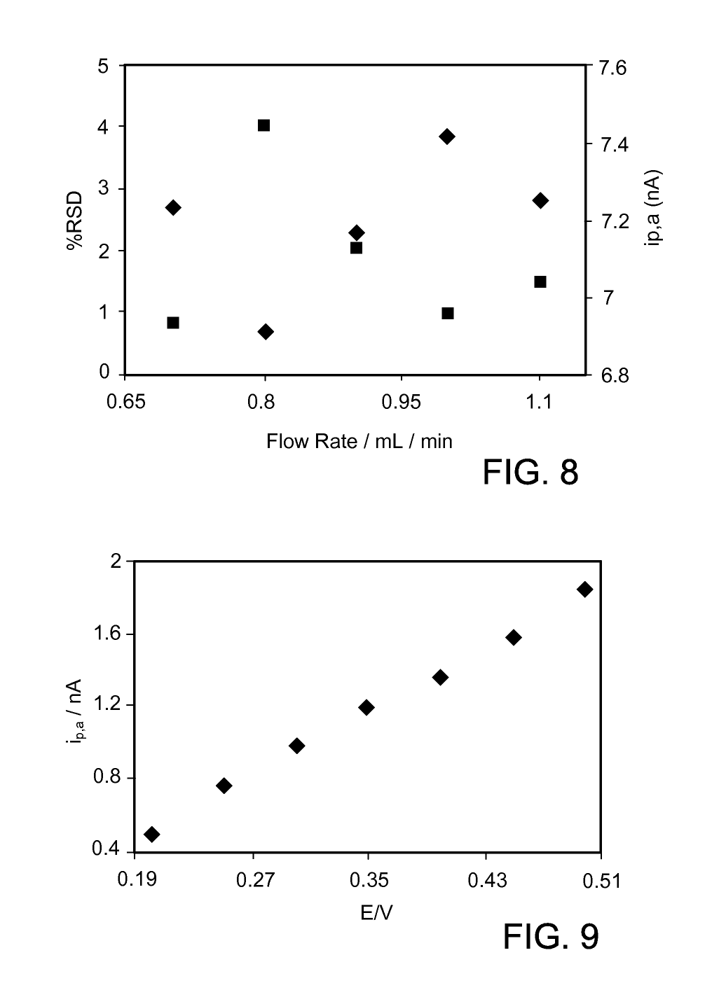

Development of preliminary design parameters for the flow cell detector was facilitated by measuring how the flow rate and applied potential affect the signal. FIG. 8 shows the flow injection amperometric responses of the electrochemical detector obtained above to three 2.1 mg/L chlorite ion injections at an applied potential of 0.2 V by plotting the reproducible standard deviation (% RSD) against the flow rate. As FIG. 8 shows that the % RSD of the measurements ranged from ˜0.75 to 4.0, a flow rate of 0.8 mL/min was chosen based on minimum variation in % RSD.

An optimized applied potential was determined by using hydrodynamic voltammetry at the optimized flow rate of 0.8 mL/min. FIG. 9 shows a hydrodynamic voltammogram of 2.5 mg/L chlorite ion at the flow cell detector described above. Based on the results shown in FIG. 9, the beginning of the limiting-current plateau region of the hydrodynamic voltammogram, i.e., about 0.5 V, was determined as the optimized applied potential. Without wishing to be bound by theory, it is believed that the pH at the working electrode surface preferably be maintained above 4 since, below this level, the structural integrity of the solid electrolyte may be compromised.

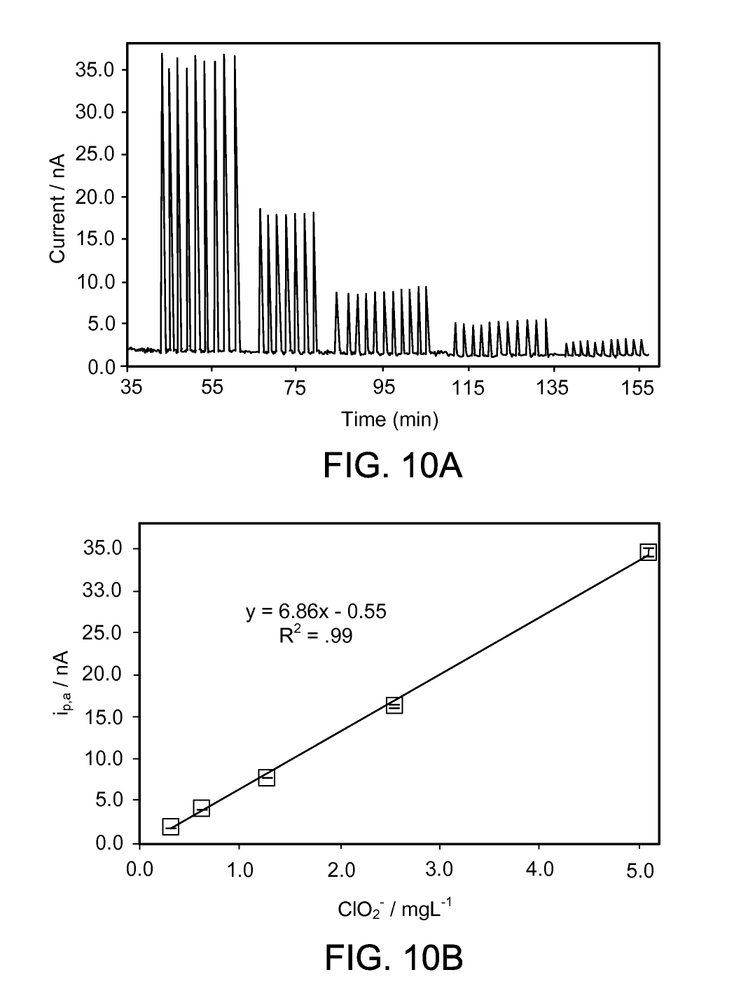

The sensitivity of the above-optimized FIA system containing the electrochemical detector prepared in Example 1 was evaluated for determination of chlorite ion in a low mg/L range by recording calibration curves of peak height vs. concentration over the range of 0.3 to 5 mg/L. Chlorite ion concentrations tested were 5.00 mg/L, 2.50 mg/L, 1.25 mg/L, 0.63 mg/L, and 0.31 mg/L. The applied potential used in this evaluation was 0.50 V. The results are shown in FIGS. 10A and 10B. Specifically, FIG. 10A is a flow injection amperometry spectrum of chlorite ion at different concentrations and FIG. 10B is the corresponding calibration curve for the electrochemical detector. Linear least squares fit of the data (5 points) yielded the following results: slope, 6.86 nA/mgL⁻¹; y-intercept, −0.55; and R², 0.99. The variation in signal when the system in at steady state was obtained by taking the standard deviation of the intercept when all points were plotted to account for sample introduction flicker noise caused by the poorly defined hydrodynamic conditions. The results show that detection limit (S/N=3) for the electrical chemical detector was 0.08 mg/L.

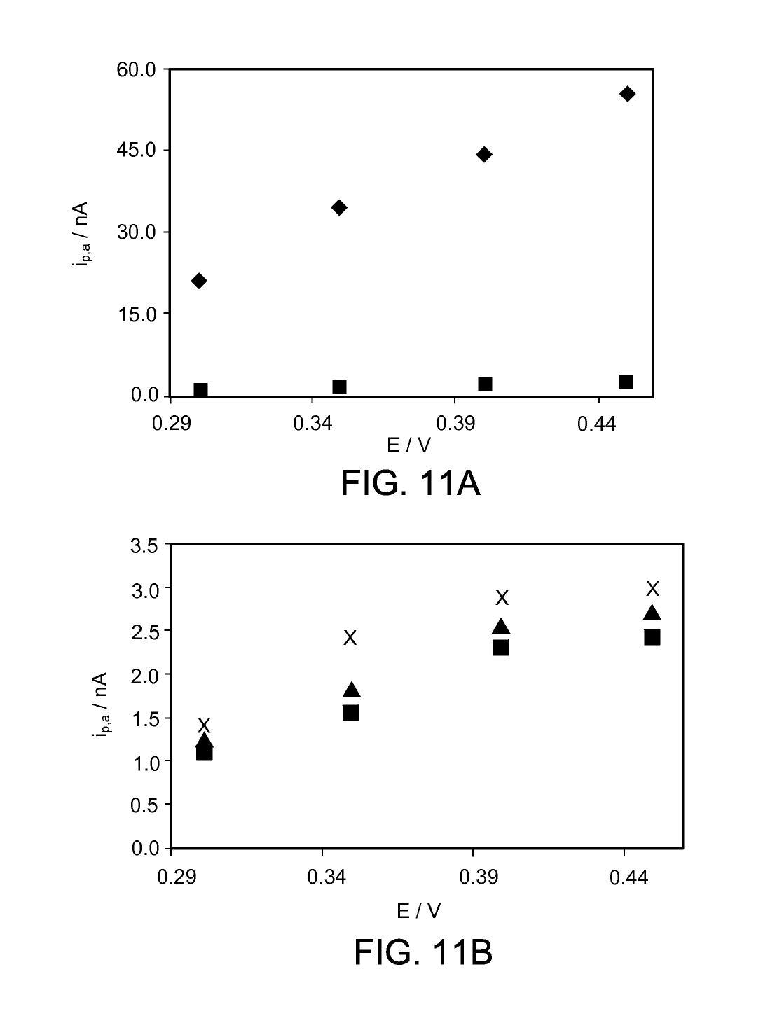

Selectivity of the electrochemical detector in the FIA system was evaluated by monitoring the detector response to solutions of chlorate and perchlorate ions. The response of 1.0 mg/L solutions containing chlorate and perchlorate ions showed small oxidation peaks, which was unexpected because no oxidation current was observed in the cyclic voltammogram of the solutions at the detector at 0.5 V. To investigate this, a hydrodynamic voltammogram was plotted with 14.8 μM chlorite ion ion (1 mg/L), 14.8 μM potassium nitrate, 12.0 μM chlorate ion (1 mg/L) and 10.0 μM perchlorate ion (1 mg/L) from 0.3-0.45 V. The results are shown in FIGS. 11A and 11B. Specifically, FIG. 11A is a hydrodynamic voltammogram of solutions containing 14.8 μM chlorite ion, 14.8 μM potassium nitrate, 12.0 μM chlorate ion, and 10.0 μM perchlorate ion detected by the detector, and FIG. 11B is a corresponding hydrodynamic voltammogram of the above solutions except for the solution containing chlorite ion. In particular, FIG. 11B is an expanded view of the bottom portion of FIG. 11A (i.e., the portion have a current intensity from 0-3 nA) and illustrates the current changes of potassium nitrate, chlorate ion, and perchlorate ion. As shown in FIG. 11A, as the potential increased, the height of the chlorite ion peak increased at a much higher rate than that of potassium nitrate, chlorate ion or perchlorate ion. In addition, as shown in FIG. 11B, the peak heights for potassium nitrate were similar in magnitude to those of chlorate ion and perchlorate ion, which suggests that the signal is non-faradaic. Without wishing to be bound by theory, it is believed that the above effect is likely due to charging of the double layer at the 3PB at the detector surface due to the higher conductivity of the sample plug compared to the deionized water carrier stream. The effect does not pose a practical problem for the FIA system described herein since the charging would build up and level off giving a constant (albeit slightly elevated) baseline.

The accuracy of the FIA system was evaluated by measuring the concentrations of two spiked validation standards. Table 1 below summarizes comparison of validation standard concentrations determined by conventional ion chromatography (IC) and the FIA system described above. As shown in Table 1, the results obtained from the FIA system described above compared well with ion chromatography. The concentrations of the validation standards obtained from the FIA system were not significantly different from the accepted values. In addition, the values obtained from the FIA system and ion chromatography were not significantly different.

TABLE 1

| Validation | Accepted Value | | |
|---|---|---|---|
| Standard | (mg/L) | IC | FIA |
| A (Xₘ ± σ) | 0.250 | 0.253 ± .007 | 0.246 ± .010 |
| B (Xₘ ± σ) | 0.876 | 0.867 ± .004 | 0.857 ± .024 |
| A (Xₘ ± t * sₘ) | 0.250 | 0.253 ± .017 | 0.246 ± .025 |
| B (Xₘ ± t * sₘ) | 0.876 | 0.867 ± .010 | 0.867 ± .060 |

Xₘ: means;
σ: standard deviation;
sₘ: standard deviation of the mean.

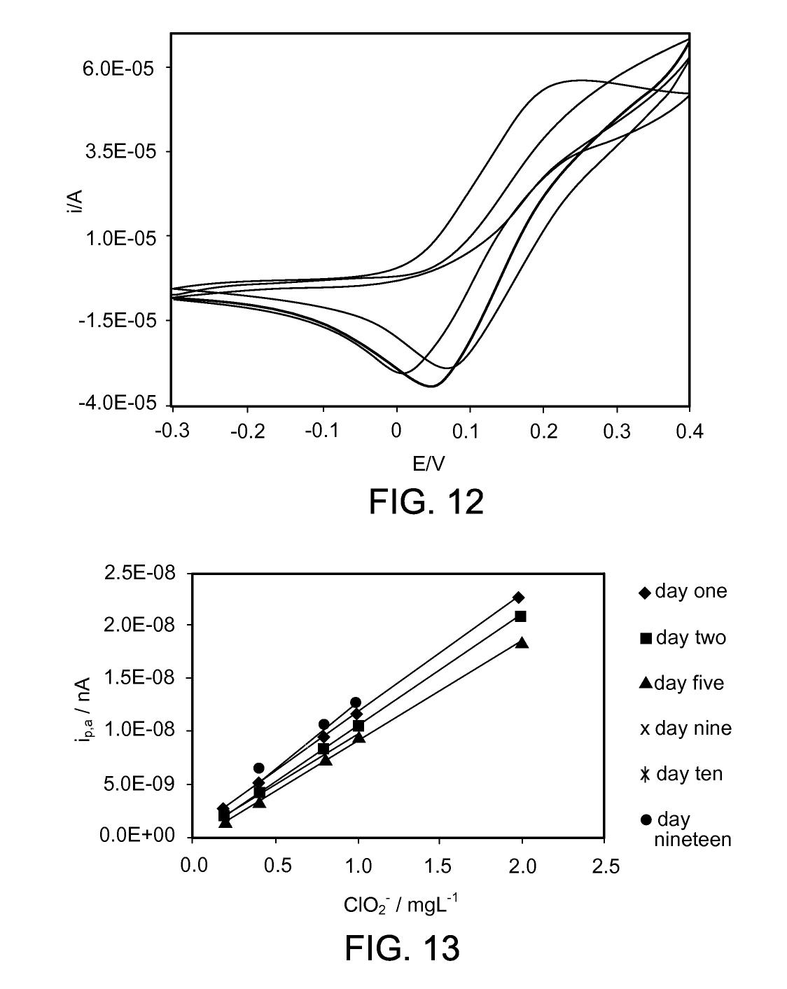

Cyclic voltammetry was used to evaluate the reproducibility of the process used to fabricate the FIA system described above. FIG. 12 shows cyclic voltammograms of 44.1 mM chlorite ion obtained from three separately fabricated FIA systems following the procedures above by using a scan rate of 100 mV/s and a pH of 10.1. Three reduction peaks were observed at ˜0.0 V, 0.05 V and 0.08 V and one clear oxidation peak was observed at ˜0.25 V. Without wishing to be bound by theory, it is believed that these small observed changes in potential may be attributed to the variable potential of the QRE based on the particular Pt/PtO ratio. Further, without wishing to be bound by theory, it is believed that the current differences are likely due to different active 3PB areas. Cyclic voltammetry scan-rate studies indicated that the current arising from the oxidation of chlorite ion at the contact point between a sample and a detector in a non-flowing system is mass-transfer limited.

The long-term stability of the FIA system described above was also tested. Specifically, calibration curves were plotted on various days after a FIA system were fabricated, when the detector was constantly flushed with a low flow rate of deionized water. FIG. 13 shows flow injection amperometric calibration curves of chlorite ion detected at the electrochemical detector in the FIA system described above. Chlorite ion concentrations used for calibration were 2.0 mg/L, 1.0 mg/L, 0.8 mg/L, 0.4 mg/L, and 0.2 mg/L. The potential applied to the detector was 0.50 V. Table 2 summarizes the parameters for calibration curves measured on days one, two, five, nine, ten and nineteen after fabrication of a prototype FIA system. As shown in Table 2, the slope fluctuated between 9.55-1.29E-08 A/mgL⁻¹ over the course of about three weeks and the detection limits ranged from 0.02-0.13 mg/L.

TABLE 2

| Day | Slope | Intercept | R2 | Detection Limit (mg/L) |
|---|---|---|---|---|
| 1 | 1.13E−08 | 4.55E−10 | 0.99 | 0.02 |
| 2 | 1.07E−08 | −8.12E−10 | 0.99 | 0.04 |
| 5 | 9.70E−09 | −6.06E−10 | 0.99 | 0.12 |
| 9 | 9.55E−09 | 1.65E−10 | 0.99 | 0.04 |
| 10 | 1.19E−08 | −3.72E−10 | 0.99 | 0.08 |
| 19 | 1.29E−08 | 3.24E−11 | 0.96 | 0.13 |

### Example 3

### Fabrication of a Gas Diffusion Flow Injection Analysis (GD-FIA) System Including an Electrochemical Detector and Measurement of Chlorine Dioxide Concentrations

Chlorine dioxide standard samples were produced based on the method described in Rosenblatt et al., J. Org. Chem. 1963, 28, 2790-2794, in which chlorine dioxide was formed by oxidizing chlorite ion by persulfate ion. Before use, chlorine dioxide stock solutions were refrigerated below 6° C. in the dark without headspace to prevent evaporation and decomposition. Dilute, aqueous chlorine dioxide solutions (e.g., <10⁻³ M) were analyzed by spectrophotometry at 259 nm utilizing a molar absorptivity value of 1250 M⁼¹ cm⁻¹. Samples were placed in capped 1 cm quartz cells and all absorbance measurements were performed using an Olis-Cary 14 spectrophotometer with a high-resolution (up to 0.1 nm) monochromator. Chlorine dioxide stock solutions were diluted and handled within a foil-wrapped 30 mL “shrinking bottle” as described in Silverman et al., Anal. Chem. 1974, 46, 178.

The electrolytic measurement of chlorine dioxide is subject to interference from chlorite ion. The selectivity for chlorine dioxide can be enhanced by using techniques that exclude non-gas phase species. For example, the detector in a FIA system may be covered with a selective, gas-permeable membrane, e.g., TEFLON®. The membrane allows passage of chlorine dioxide gas molecules, but substantially excludes non-gas phase species that may be dissolved in the sample, such as chlorite ions, that might create interference. When the chlorine dioxide gas transits the membrane, it is reduced to chlorite ion at an electrode in the detector and is detected by the detector. To use a selective separation membrane with the FIA system described in Example 1, a prototype GD-FIA system was fabricated for chlorine dioxide measurement. The system consisted of a donor stream supplied by a syringe pump connected to a Rheodyne 7125 6-port syringe loading injection valve with a 250 μL external sampling loop and a separate acceptor stream, both connected to a Tecator Chemifold V gas-diffusion manifold in a countercurrent arrangement. The detector included the electrochemical detector prepared in Example 1 deployed in a flow cell as described in Example 2. An ACE TEFLON® tape was used as the selective, gas-permeable separation membrane. The flow rates of the donor and acceptor streams were 0.75 mL/min of deionized water unless otherwise indicated. The flow system used 0.5-mm-i.d. Tygon tubing. Fixed-potential amperometric i-t curves were recorded using this GD-FIA system and the resultant peak heights were measured using GRAMS/31AI software.

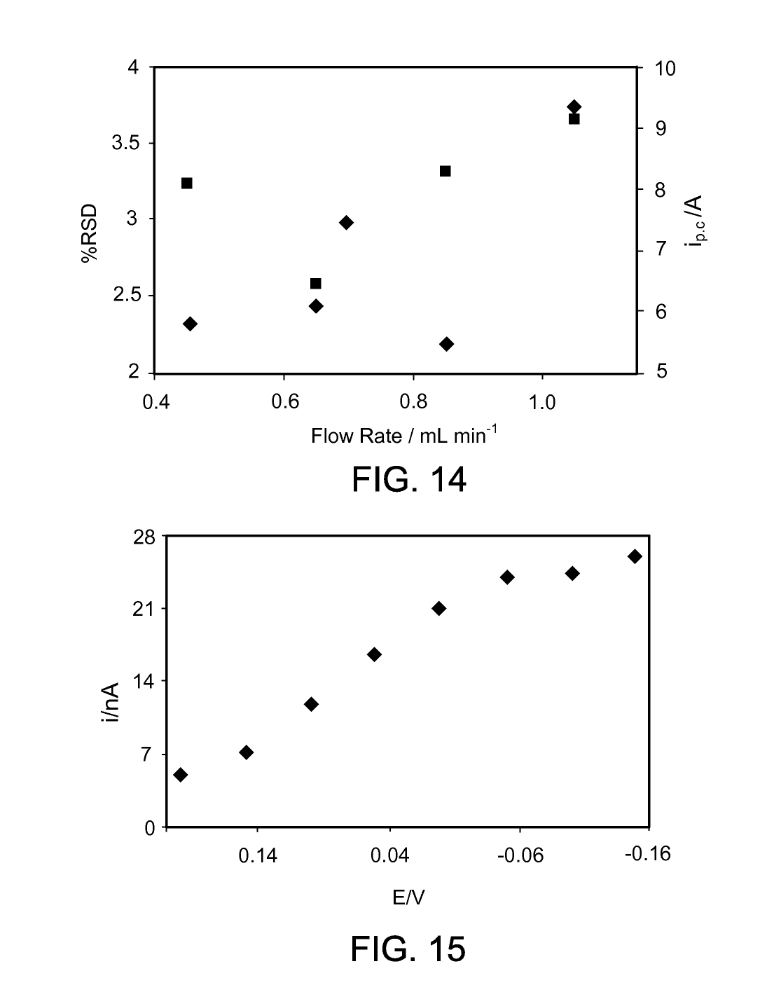

Without wishing to be bound by theory, it is believed that improved performance for a non-reacting species was achieved when the donor and acceptor streams had equal flow rates that were as low as possible in a countercurrent flow configuration. However, as described in Example 2, flow rate had a large effect on the hydrodynamic conditions with the electrochemical detector in a FIA system. To investigate this, the reduction current signal (i_{p,c}) was plotted vs. flow rate. FIG. 14 shows flow injection amperometric responses of an electrochemical detector prepared in Example 1 in a GD-FIA system to three 3.8 mg/L chlorine dioxide injections at an applied potential of 0.0 V, as well as their % RSD vs. flow rate. The lowest % RSD occurred at 0.85 mL/min and was thus used.

The optimized applied potential was found by plotting a hydrodynamic voltammogram at a low flow rate. FIG. 15 is a hydrodynamic voltammogram of 3.8 mg/L chlorine dioxide using the GD-FIA system described above at a flow rate of 0.45 mL/min. The beginning of the limiting-current plateau region of the hydrodynamic voltammogram, −0.05 V, was determined as the optimized applied potential. Lower potentials were not investigated because they resulted in increases in background current arising from the reduction of hydronium and water. Without wish to be bound by theory, it is believed that, if the pH at the working electrode surface were to dramatically increase above 4, the structural integrity of the solid electrolyte may be compromised.

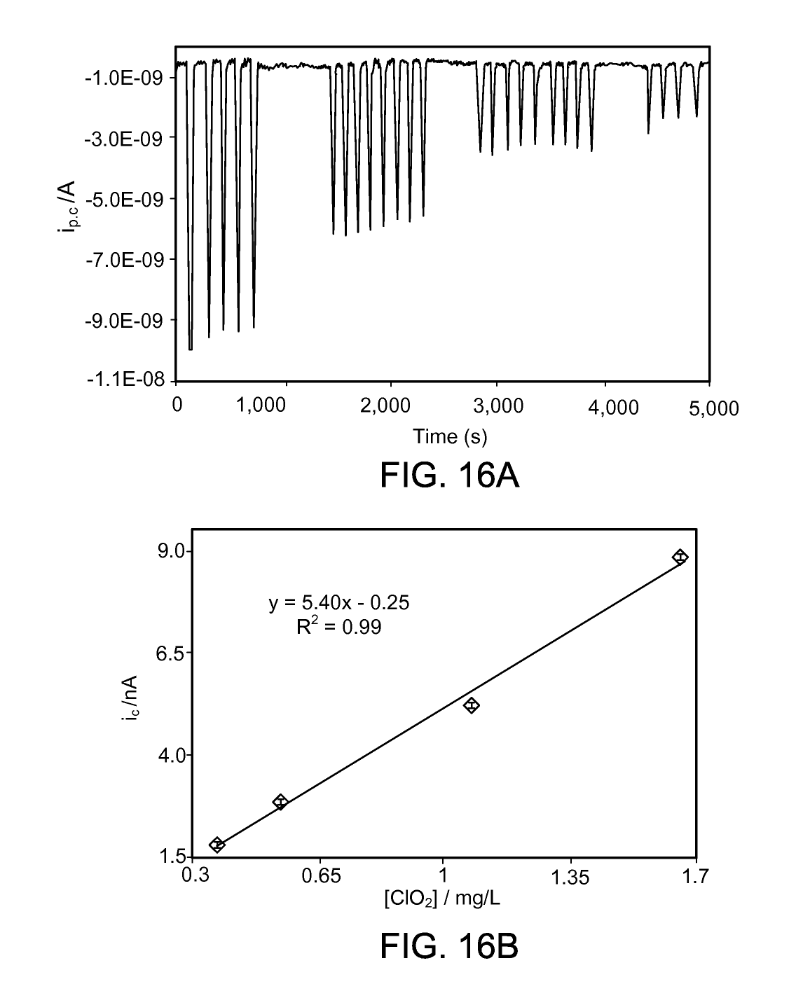

The sensitivity of an optimized GD-FIA system having the electrochemical detector containing a solid-electrolyte for the determination of chlorine dioxide in the low mg/L range was evaluated by recording calibration curves of peak height vs. concentration over the range of 0.3 to 1.6 mg/L. Chlorine dioxide concentrations were 1.6 mg/L, 1.1 mg/L, 0.5 mg/L, and 0.35 mg/L. The applied potential was −0.05 V. The results are shown in FIGS. 16A and 16B. Specifically, FIG. 16A is a flow injection amperometry spectrum of chlorine dioxide at different concentrations and FIG. 16B is the corresponding calibration curve for the electrochemical detector. Linear least squares fit of the data (4 points) yielded the following results: slope, 5.40 nA/mgL⁻¹; y-intercept, −0.25; and R², 0.99. The variation in signal when the system in at steady state was obtained by taking the standard deviation of the intercept. The results show that detection limit (S/N=3) for the electrical chemical detector was 0.08 mg/L. Injections of 10 mg/L solutions of chlorite, chlorate, and perchlorate ions could not be distinguished from the baseline, which demonstrates selectivity for chlorine dioxide.

Other embodiments are within the scope of the claims.

What is claimed is:

1. A method of detecting an analyte, comprising:
contacting an aqueous solution containing the analyte with an electrochemical detector having a working electrode, a counter electrode, and a solid electrolyte, the analyte comprising a halogen or an oxy-halogen species and the solid electrolyte providing an electrical pathway between the working and counter electrodes;
applying a voltage to the detector; and
measuring the resultant current change in the detector.

2. The method of claim 1, wherein the oxy-halogen species is an oxy-chlorine species.

3. The method of claim 2, wherein the oxy-chlorine species is chlorite ion or chlorine dioxide.

4. The method of claim 1, wherein the halogen or the oxy-halogen species is a disinfectant or a by-product thereof.

5. The method of claim 1, wherein the aqueous solution comprises the analyte in the range of from about 0 mg/L to about 5 mg/L.

6. The method of claim 1, wherein the solid electrolyte comprises a solid matrix and an electrically conducting material.

7. The method of claim 6, wherein the matrix comprises an oxide.

8. The method of claim 7, wherein the oxide comprises silica, alumina, titania, or zirconia.

9. The method of claim 8, wherein the matrix is at least partially cross-linked.

10. The method of claim 6, wherein the electrically conducting material comprises ammonium hexafluorophosphate, magnesium chloride, or tetramethylammonium phosphate.

11. The method of claim 6, wherein, during use, the amount of the electrically conducting material is substantially maintained in the solid electrolyte.

12. The method of claim 1, wherein the solid electrolyte is formed by a sol gel process.

13. The method of claim 12, wherein the solid electrolyte is formed from a dispersion or a solution comprising an oxide precursor, a solvent, and an electrically conducting material, and optionally a surfactant.

14. The method of claim 13, wherein the oxide precursor comprises an alkoxide.

15. The method of claim 14, wherein the oxide precursor comprises a silicon alkoxide.

16. The method of claim 15, wherein the silicon alkoxide is silicon tetraethoxide or silicon tetramethoxide.

17. The method of claim 13, wherein the surfactant is an ethylene glycol monoether or a polyethylene glycol monoether.

18. The method of claim 17, wherein the surfactant is polyethylene glycol (1,1,3,3-tetramethylbutyl)phenyl ether.

19. The method of claim 13, wherein the solvent comprises water, methanol, ethanol, or a mixture thereof.

20. The method of claim 13, wherein the sol gel process is an evaporation-induced self-assembly process or an electrochemically-assisted self-assembly process.

21. The method of claim 1, wherein the detector further comprises a reference electrode, and the solid electrolyte provides an electrical pathway between the reference electrode, the working electrode, and the counter electrode.

22. The method of claim 21, wherein the working, counter, or reference electrode comprises platinum, gold, silver, graphite, glassy carbon, or a mixture thereof.

23. The method of claim 1, wherein the voltage is applied to the detector by using amperometry or cyclic voltammetry.

24. The method of claim 1, wherein the voltage is capable of inducing redox reaction of the analyte.

25. The method of claim 1, wherein the voltage is at least about −0.95 V.

26. The method of claim 1, wherein the voltage is at least about −1.15 V.

27. A system, comprising:
a sample-delivering device for delivering a sample containing an analyte into a carrier fluid; and
an electrochemical detector for detecting the analyte,
wherein the detector is downstream from and in fluid communication with the first delivering device, the detector comprises a working electrode, a counter electrode, and a solid electrolyte, and the solid electrolyte provides an electrical pathway between the working and counter electrodes.

28. The system of claim 27, further comprising a fluid-delivering device for delivering the carrier fluid and a sample collector for acquiring a sample.

29. The system of claim 27, further comprising a potentiometer electrically connected to the detector, wherein the potentiometer is configured to apply a voltage to the detector.

30. The system of claim 29, further comprising an ammeter electrically connected to the detector, wherein the ammeter is configured to measure a current change in the detector while a voltage is being applied.

31. The system of claim 30, further comprising a processor configured to analyze data obtained from the ammeter.

32. The system of claim 27, further comprising a gas diffusion cell downstream from the sample-delivering device and upstream from the detector, the gas diffusion cell being in fluid communication with the sample-delivering device and the detector.

33. The system of claim 32, wherein the gas diffusion cell comprises a membrane capable of separating gas molecules in the sample from ions.

34. The system of claim 33, wherein the membrane is further capable of separating different types of gasses.

35. The system of claim 34, wherein the membrane comprises polytetrafluoroethylene.

36. The system of claim 32, further comprising a first fluid-delivering device configured to deliver a donor stream to the gas diffusion cell.

37. The system of claim 36, further comprising a second fluid-delivering device configured to deliver an acceptor stream to the gas diffusion cell.

38. The system of claim 37, wherein the first or second fluid-delivering device is a syringe pump.

39. The system of claim 37, wherein the gas diffusion cell is configured such that the donor stream and the acceptor stream are in a countercurrent arrangement in the gas diffusion cell.

40. The system of claim 37, wherein the gas diffusion cell is configured to deliver the acceptor stream to the detector.

41. The system of claim 37, wherein the gas diffusion cell is configured to deliver the donor stream to the detector.

42. The system of claim 27, further comprising a separating device for separating constituents in the sample prior to contacting the sample with the detector.

43. The system of claim 42, wherein the separating device comprises a membrane.

44. The system of claim 27, wherein the detector further comprises a reference electrode, and the solid electrolyte provides an electrical pathway between the reference electrode, the working electrode, and the counter electrode.

45. The system of claim 27, wherein the system is a flow injection analysis system or a gas diffusion flow injection system.
